(19) United States
(12) Patent Application Publication
(10) Pub. No.: US 2014/0101950 A1
(43) Pub. Date: Apr. 17, 2014

(54) Spirit level with LED indicators

(71) Applicant: Zhejiang Rongsheng Tool Co., Ltd., Jinhua City (CN)

(72) Inventor: Chengrong Zhuang, Jinhua City (CN)

(21) Appl. No.: 13/924,489

(22) Filed: Jun. 21, 2013

(30) Foreign Application Priority Data
Oct. 11, 2012 (CN) 201210385837.3

(51) Int. Cl. G01C 9/32

(52) U.S. Cl. CPC G01C 9/32
USPC 33/348.2

(57) ABSTRACT

A spirit level includes a housing, a cap at one end of the housing, a battery assembly at an other end of the housing, a LED indication assembly at a center of the housing, a vertical orientation indication assembly between the LED indication assembly and the cap, a forty-five-degree orientation indication assembly between the

LED indication assembly and the battery compartment, and a PCB and angle sensing circuit electrically connected to the battery assembly, the LED indication assembly, the vertical orientation indication assembly, and the forty-five-degree orientation indication assembly respectively.

### BACKGROUND OF THE INVENTION

1. Field of the Invention

The invention relates to leveling devices and more particularly to a spirit level having light-emitting diode (LED) indicators.

2. Description of Related Art

Many construction projects such as house repairs require accurate alignment of various components in relation to a ground surface. Such practice allows for proper construction of necessarily level surfaces such as floors and helps to maintain relative alignment between various portions of the construction. Spirit levels are typical tools utilized for such applications. A primary drawback of typical spirit levels is that due to the sight based nature of the levelness indicators, accurate assessment of whether a surface is horizontal, vertical, or forty-five degree angle relative to a desired plane by a user's eyesight is required. Such conditions require the user to be able to accurately assess the level's readings in order to ensure proper construction. But such readings are made difficult and potentially inaccurate by environmental factors which limit visibility such as shadows, low-light situations, etc. Such factors are particularly prevalent on construction sites due to the transitory nature of the construction which often precludes the presence of proper lighting and visibility. Notwithstanding the prior art, the invention is neither taught nor rendered obvious thereby.

### SUMMARY OF THE INVENTION

It is therefore one object of the invention to provide a spirit level with LED indicators for improving reading by a user's eyesight.

In one aspect of the invention, a spirit level comprising a housing; a cap disposed at one end of the housing; a battery assembly disposed at an other end of the housing; a LED indication assembly disposed at a center of the housing; a vertical orientation indication assembly disposed between the LED indication assembly and the cap; a forty-five-degree orientation indication assembly disposed between the LED indication assembly and the battery assembly; and a printed circuit board (PCB) and angle sensing circuit electrically connected to the battery assembly, the LED indication assembly, the vertical orientation indication assembly, and the forty-five-degree orientation indication assembly respectively.

Preferably, the housing is made of aluminum alloy.

Preferably, the LED indication assembly comprises a front cover, a dust cover, a horizontal vial, a support, a LED-backlit liquid crystal display (LCD) panel, a bracket, an on/off switch, a button, a buzzer, and a rear cover; and wherein the horizontal vial is disposed on the support, the support is disposed on the bracket, the bracket is secured to the housing, the PCB and angle sensing circuit is secured to the rear cover, and the front cover, the dust cover, and the rear cover are secured to the housing.

Preferably, the vertical orientation indication assembly comprises a front cover, a vertical vial, a support, a vertical orientation LED indicator, and a rear cover; and wherein the vertical vial is disposed on the support, the support is secured to the housing, the vertical orientation LED indicator is disposed on the support, and the vertical orientation LED indicator is electrically connected to the PCB and angle sensing circuit.

Preferably, the forty-five-degree orientation indication assembly comprises a forty-five-degree orientation vial, a support, a forty-five-degree orientation LED indicator, a front cover, and a rear cover; and wherein the forty-five-degree orientation vial is disposed on the support, the support is secured to the housing, the forty-five-degree orientation LED indicator is disposed on the support, and the forty-five-degree orientation LED indicator is electrically connected to the PCB and angle sensing circuit.

Preferably, the LED indication assembly comprises a horizontal vial, the vertical orientation indication assembly comprises a vertical via, and the forty-five-degree orientation indication assembly comprises a forty-five-degree orientation vial respectively so that a user may determine whether a surface is horizontal, vertical, or at a forty-five-degree angle by viewing a bubble in each of the vials. Further, two or three color LEDs are provided in each of the LED indication assembly, the vertical orientation indication assembly, and the forty-five-degree orientation indication assembly. One of the color LEDs associated with one of the LED indication assembly, the vertical orientation indication assembly, and the forty-five-degree orientation indication assembly may emit light or flash in response to different orientations of the spirit level sensed by the PCB and angle sensing circuit.

The spirit level of the invention has the following advantages in comparison with typical spirit levels:

Improved reliability, more accurate reading, and durability can be obtained.

A corresponding color light is emitted by a LED for easy visual observation in response to a sensing by the PCB and angle sensing circuit when the spirit level is on a horizontal, vertical, or forty-five-degree surface.

Alternatively, a warning is issued by the flashing LED in response to an abnormal orientation of the spirit level.

Additionally, a buzzer is activated to make a buzzing sound when the warning is issued.

Additional illumination methods can be added to the constant illumination and flashing of the LEDs so that a user may more accurately determine whether a surface is horizontal, vertical, or at a forty-five-degree angle with the help of the activated LEDs and other means.

The above and other objects, features and advantages of the invention will become apparent from the following detailed description taken with the accompanying drawings.

### BRIEF DESCRIPTION OF THE DRAWINGS

FIG. 1 is a top view of a spirit level according to the invention;

FIG. 2 is a longitudinal sectional view of the spirit level;

FIG. 3 is a perspective view of the LED indication assembly;

FIG. 4 is a perspective view of the vertical orientation indication assembly; and

FIG. 5 is a perspective view of the forty-five-degree orientation indication assembly.

### DETAILED DESCRIPTION OF THE INVENTION

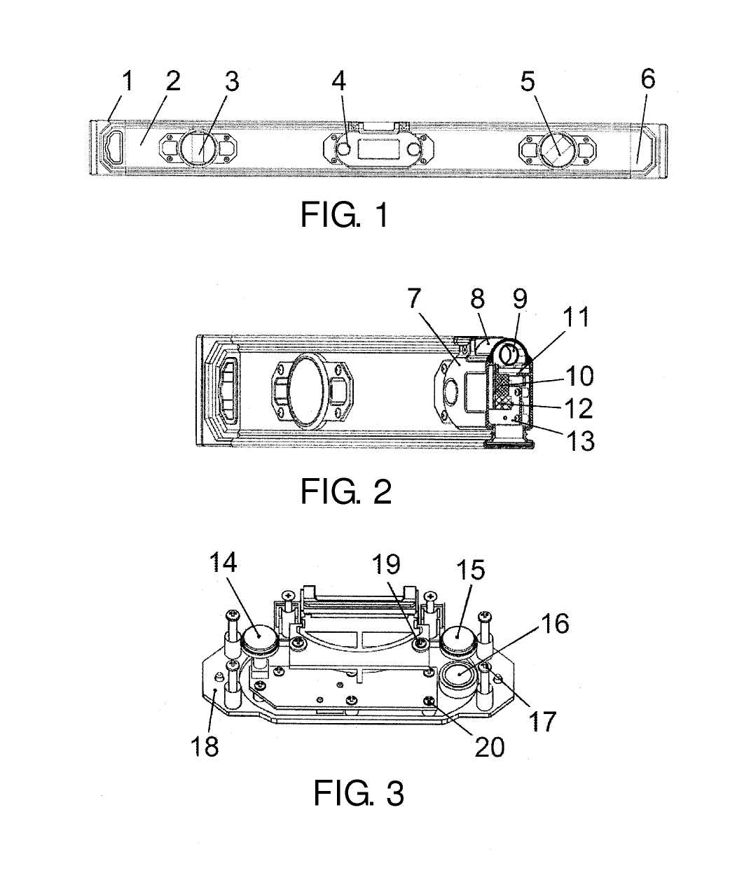

Referring to FIGS. 1 to 5, a spirit level in accordance with the invention comprises the following components as discussed in detail below.

A cap 1 is provided at one end of housing 2 made of aluminum alloy. A battery compartment 6 having cells disposed therein is provided at an other end of the housing 2. The cells thus supply electricity to the spirit level for its operation. A LED indication assembly 4 is provided at a center of the housing 2. A vertical orientation indication assembly 3 is provided between the LED indication assembly 4 and the cap 1 and a forty-five-degree orientation indication assembly 5 is provided between the LED indication assembly 4 and the battery compartment 6.

As shown in FIGS. 2 and 3 specifically, the LED indication assembly 4 comprises a front cover 7, a dust cover 8, a horizontal vial 9, a first support 10, a LED-backlit liquid crystal display (LCD) panel 11, a bracket 12, a printed circuit board (PCB) and angle sensing circuit 13 electrically connected to the cells in the battery compartment 6, an on/off switch 14, a button 15, a buzzer 16 electrically connected to the PCB and angle sensing circuit 13, a plurality of first screws 17, a rear cover 18, a plurality of second screws 19, and a plurality of third screws 20. The horizontal vial 9 is provided on the first support 10. The first support 10 is provided on the bracket 12. The second screws 19 are driven through the bracket 12 into the housing 2 for fastening. The third screws 20 are driven through the PCB and angle sensing circuit 13 into the rear cover 18 for fastening. The first screws 17 are driven through the front cover 7, the dust cover 8, and the rear cover 18 into the housing 2 for fastening.

Operations of the invention are described in detail below. In response to the PCB and angle sensing circuit 13 sensing the spirit level being horizontal in relation to a desired plane, the LED-backlit LCD panel 11 emits green light to illuminate the horizontal vial 9. Also, the buzzer 16 makes a sound for alert. In response to the PCB and angle sensing circuit 13 sensing the spirit level being at a predetermined acute angle in relation to a desired plane, the LED-backlit LCD panel 11 emits red light to illuminate the horizontal vial 9. In response to the PCB and angle sensing circuit 13 sensing the spirit level being at an angle between being horizontal and the predetermined acute angle in relation to a desired plane, the LED-backlit LCD panel 11 flashes to visually warn a user that the spirit level is required to be calibrated.

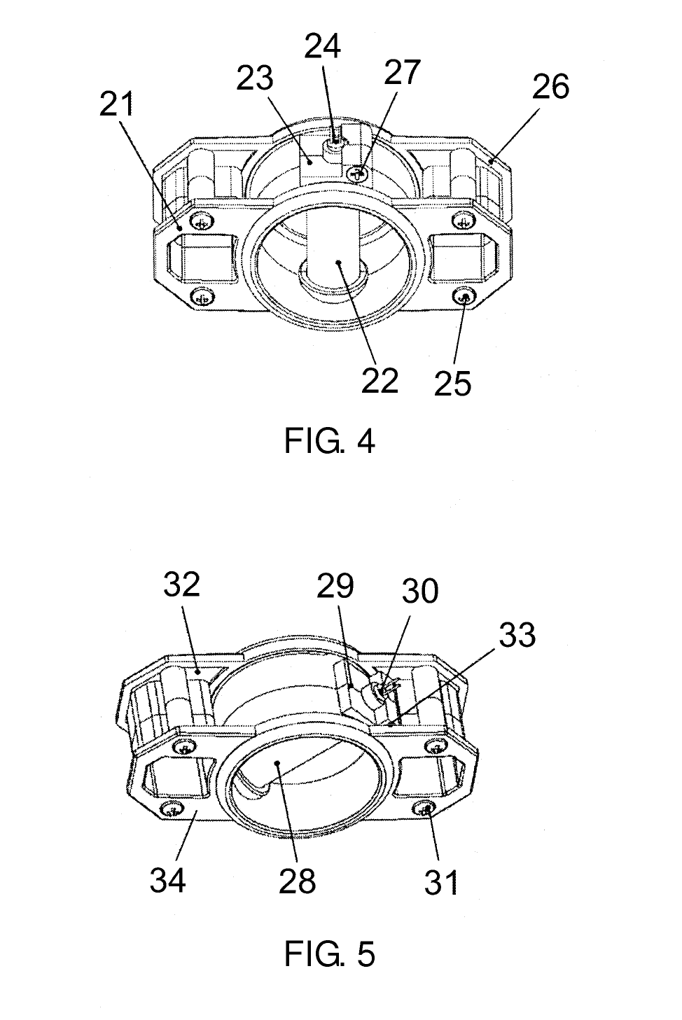

As shown in FIG. 4 specifically, the vertical orientation indication assembly 3 comprises a front cover 21, a vertical vial 22, a second support 23, a vertical orientation LED indicator 24, a plurality of fourth screws 25, a rear cover 26, and a plurality of fifth screws 27. The vertical vial 22 is provided on the second support 23. The fifth screws 27 are driven through the second support 23 into the housing 2 for fastening. The vertical orientation LED indicator 24 is provided on the second support 23. The vertical orientation LED indicator 24 is electrically connected to the PCB and angle sensing circuit 13. Thus, constant illumination, flashing, and color change of the orientation LED indicator 24 can be controlled by the PCB and angle sensing 13.

Operations of the invention are further described in detail below. Red and green LED indicators are provided on the second support 23. In response to the PCB and angle sensing circuit 13 sensing the spirit level being vertical in relation to a desired plane, the green LED indicator on the second support 23 emits green light to illuminate the vertical vial 22. Also, the buzzer 16 makes a sound for alert. In response to the PCB and angle sensing circuit 13 sensing the spirit level being at a predetermined acute angle in relation to a desired plane, the red LED indicator on the second support 23 emits red light to illuminate the vertical vial 22. In response to the PCB and angle sensing circuit 13 sensing the spirit level being at an angle between being vertical and the predetermined acute angle in relation to a desired plane, the green LED indicator on the second support 23 flashes to visually warn a user that the spirit level is required to be calibrated.

As shown in FIG. 5 specifically, the forty-five-degree orientation indication assembly 5 comprises a forty-five-degree orientation vial 28, a third support 29, a forty-five-degree orientation LED indicator 30, a plurality of sixth screws 31, a front cover 34, a rear cover 32, and a plurality of seventh screws 33. The forty-five-degree orientation vial 28 is provided on the third support 29. The seventh screws 33 are driven through the third support 29 into the housing 2 for fastening. The forty-five-degree orientation LED indicator 30 is provided on the third support 29. The forty-five-degree orientation LED indicator 30 is electrically connected to the PCB and angle sensing circuit 13. Thus, constant illumination, flashing, and color change of the forty-five-degree orientation LED indicator 30 can be controlled by the PCB and angle sensing 13.

Operations of the invention are further described in detail below. Red and green LED indicators are provided on the third support 29. In response to the PCB and angle sensing circuit 13 sensing the spirit level being at forty-five-degree orientation in relation to a desired plane, the green LED indicator on the third support 29 emits green light to illuminate the forty-five-degree orientation vial 28. Also, the buzzer 16 makes a sound for alert. In response to the PCB and angle sensing circuit 13 sensing the spirit level being at a predetermined acute angle in relation to a desired plane, the red LED indicator on the third support 29 emits red light to illuminate the forty-five-degree orientation vial 28. In response to the PCB and angle sensing circuit 13 sensing the spirit level being at an angle between forty-five degrees and the predetermined acute angle in relation to a desired plane, the green LED indicator on the third support 29 flashes to visually warn a user that the spirit level is required to be calibrated.

Alternatively, in other preferred embodiments, at least one of the vertical orientation indication assembly 3 and the forty-five-degree orientation indication assembly 5 is eliminated from the spirit level.

Alternatively, in other preferred embodiments, LED indicators having a color other than read and green can be implemented in the LED-backlit LCD panel 11, the vertical orientation indication assembly 3, the forty-five-degree orientation indication assembly 5.

Alternatively, in other preferred embodiments, short illumination can be added to above constant illumination and flashing.

While the invention has been described in terms of preferred embodiments, those skilled in the art will recognize that the invention can be practiced with modifications within the spirit and scope of the appended claims.

What is claimed is:

1. A spirit level comprising:
a housing;
a cap disposed at one end of the housing;
a battery assembly disposed at an other end of the housing;
a light-emitting diode (LED) indication assembly disposed at a center of the housing;
a vertical orientation indication assembly disposed between the LED indication assembly and the cap;
a forty-five-degree orientation indication assembly disposed between the LED indication assembly and the battery assembly; and
a printed circuit board (PCB) and angle sensing circuit electrically connected to the battery assembly, the LED indication assembly, the vertical orientation indication assembly, and the forty-five-degree orientation indication assembly respectively.

2. The spirit level of claim 1, wherein the LED indication assembly comprises a front cover, a dust cover, a horizontal vial, a support, a LED-backlit liquid crystal display (LCD) panel, a bracket, an on/off switch, a button, a buzzer, and a rear cover; and
wherein the horizontal vial is disposed on the support, the support is disposed on the bracket, the bracket is secured to the housing, the PCB and angle sensing circuit is secured to the rear cover, and the front cover, the dust cover, and the rear cover are secured to the housing.

3. The spirit level of claim 1, wherein the vertical orientation indication assembly comprises a front cover, a vertical vial, a support, a vertical orientation LED indicator, and a rear cover; and wherein the vertical vial is disposed on the support, the support is secured to the housing, the vertical orientation LED indicator is disposed on the support, and the vertical orientation LED indicator is electrically connected to the PCB and angle sensing circuit.

4. The spirit level of claim 1, wherein the forty-five-degree orientation indication assembly comprises a forty-five-degree orientation vial, a support, a forty-five-degree orientation LED indicator, a front cover, and a rear cover; and wherein the forty-five-degree orientation vial is disposed on the support, the support is secured to the housing, the forty-five-degree orientation LED indicator is disposed on the support, and the forty-five-degree orientation LED indicator is electrically connected to the PCB and angle sensing circuit.

5. The spirit level of claim 1, wherein the housing is made of aluminum alloy.

6. A spirit level comprising:
a housing;
a cap disposed at one end of the housing;
a battery assembly disposed at an other end of the housing;
a light-emitting diode (LED) indication assembly disposed at a center of the housing; and
a printed circuit board (PCB) and angle sensing circuit electrically connected to the battery assembly and the LED indication assembly respectively.

7. The spirit level of claim 6, further comprising a vertical orientation indication assembly disposed between the LED indication assembly, the vertical orientation indication assembly comprising a front cover, a vertical vial, a support, a vertical orientation LED indicator, and a rear cover, and wherein the vertical vial is disposed on the support, the support is secured to the housing, the vertical orientation LED indicator is disposed on the support, and the vertical orientation LED indicator is electrically connected to the PCB and angle sensing circuit.

8. The spirit level of claim 6, further comprising a forty-five-degree orientation indication assembly disposed between the LED indication assembly and the battery assembly, the forty-five-degree orientation indication assembly comprising a forty-five-degree orientation vial, a support, a forty-five-degree orientation LED indicator, a front cover, and a rear cover, and wherein the forty-five-degree orientation vial is disposed on the support, the support is secured to the housing, the forty-five-degree orientation LED indicator is disposed on the support, and the forty-five-degree orientation LED indicator is electrically connected to the PCB and angle sensing circuit.

9. The spirit level of claim 6, further comprising a buzzer electrically connected to the PCB and angle sensing circuit.
